(19) United States
(12) Patent Application Publication
(10) Pub. No.: US 2021/0357624 A1
(43) Pub. Date: Nov. 18, 2021

(54) INFORMATION PROCESSING METHOD AND DEVICE, AND STORAGE MEDIUM

(71) Applicant: SHENZHEN SENSETIME TECHNOLOGY CO., LTD., Shenzhen (CN)

(72) Inventors: Xuyang YAN, Shenzhen (CN); Gang GAN, Shenzhen (CN); Enlong ZHANG, Shenzhen (CN); Guanliang LI, Shenzhen (CN); Yiren ZENG, Shenzhen (CN)

(21) Appl. No.: 17/386,740

(22) Filed: Jul. 28, 2021

Related U.S. Application Data
(63) Continuation of application No. PCT/CN2020/089562, filed on May 11, 2020.

(30) Foreign Application Priority Data
Jun. 28, 2019 (CN) 201910580576.2

(51) Int. Cl. G06K 9/00; G06T 7/70; G06K 9/62

(52) U.S. Cl. CPC G06K 9/00248; G06T 7/70; G06K 9/00295; G06K 2209/21; G06K 9/6272; G06T 2207/30196; G06K 9/00369

(57) ABSTRACT

An information processing method and device, and a storage medium are provided. The method includes: obtaining first input information, the first input information including at least an image containing a target object (101); obtaining, based on the first input information, captured images of the target object that are captured by an image acquisition device within a time period from N seconds before a target time point till N seconds after the target time point, the target time point being the time point when the image acquisition device captures the target object (102); determining companions of the target object from the captured images (103); and acquiring a companion identifying result by analyzing the one or more companions based on aggregated profile data, each person in the aggregated profile data corresponding to a unique profile (104).

### CROSS-REFERENCE TO RELATED APPLICATION

This application is a continuation of International Patent Application No. PCT/CN2020/089562, filed on May 11, 2020, which claims priority to Chinese Patent Application No. 201910580576.2, filed on Jun. 28, 2019. The disclosures of International Patent Application No. PCT/CN2020/089562 and Chinese Patent Application No. 201910580576.2 are hereby incorporated by reference in their entireties.

### BACKGROUND

When the public security department conducts case investigation on a daily basis, it is very likely that there will be no face picture of a target suspect and other relevant information conducive to case solving, and at this time, it is difficult to conduct profile analysis for the person. But sometimes, criminals will carry out criminal activities in form of gangs, that is, sometimes a target suspect may have a suspicious companion. When clues to a suspect are blocked or a criminal gang is to be found, finding the suspect's companion may provide effective clues for solving a case. Therefore, there is a pressing need for a solution for determining a suspect's companion.

### SUMMARY

The present disclosure relates to the field of information processing. Embodiments of the present disclosure provide a method and device for information processing, and a storage medium, which enables to quickly identify a companion of a target object.

According to a first aspect of the embodiments of the present disclosure, there is provided a method for information processing, which includes:
acquiring first input information, the first input information including at least an image containing a target object;

acquiring, based on the first input information, capture images of the target object that are captured by an image collecting device within a time period from N seconds before a target time point till N seconds after the target time point, the target time point being a time point when the image collecting device captures the target object;

determining one or more companions of the target object in the capture images; and

acquiring a companion identifying result by analyzing the one or more companions based on aggregated profile data. Each person in the aggregated profile data corresponds to a unique profile.

According to a second aspect of the embodiments of the present disclosure, there is provided a device for information processing, which includes:

a first acquiring module, configured for acquiring first input information, the first input information including at least an image containing a target object;

a second acquiring module, configured for acquiring, based on the first input information, capture images of the target object that are captured by an image collecting device within a period from N seconds before a target time point till N seconds after the target time point, the target time point being a time point when the image collecting device captures the target object;

a determining module, configured for determining one or more companions of the target object in the capture images; and

a processing module, configured for acquiring a companion identifying result by analyzing the one or more companions based on aggregated profile data. Each person in the aggregated profile data corresponds to a unique profile.

According to a third aspect of the embodiments of the present disclosure, there is provided a device for information processing, which includes: memory, a processor, and a computer program stored in the memory and executable by the processor. The processor is configured for implementing the steps of the method for information processing in the embodiments of the present disclosure.

According to a fourth aspect of the embodiments of the present disclosure, there is provided a computer storage medium having stored thereon a computer program which, when executed by a processor, enable the processor to implement the steps of the method for information processing in the embodiments of the present disclosure.

According to a fifth aspect of the embodiments of the present disclosure, there is provided a computer program including a computer-readable code which, when run on electronic equipment, causes a processor of the electronic equipment to implement steps of the method for information processing in the embodiments of the present disclosure.

The general description above and the elaboration below are exemplary and explanatory only, and do not limit the present disclosure.

### BRIEF DESCRIPTION OF THE ACCOMPANYING DRAWINGS

Drawings here are incorporated in and constitute part of the present disclosure, illustrate embodiments according to the present disclosure, and together with the present disclosure, serve to explain the technical solution of the present disclosure.

With reference to the drawings, the present disclosure may be understood more clearly according to the following elaboration, in which:

FIG. 1 is a flowchart of a method for information processing according to an embodiment of the present disclosure.

FIG. 2 is a diagram of a query result of the number of companion times according to an embodiment of the present disclosure.

FIG. 3 is a diagram of a query result of companion records for a target object and a single companion according to an embodiment of the present disclosure.

FIG. 4 is a schematic diagram of a query result of positions where a companion appears according to an embodiment of the present disclosure.

FIG. 5 is a diagram of an analysis result of a single video source according to an embodiment of the present disclosure.

FIG. 6 is a diagram of a principle of a face clustering algorithm according to an embodiment of the present disclosure.

FIG. 7 is a flowchart of performing face clustering according to an embodiment of the present disclosure.

FIG. 8 is a diagram of a face clustering result according to an embodiment of the present disclosure.

FIG. 9 is a flowchart of establishing a profile according to an embodiment of the present disclosure.

FIG. 10 is a diagram of a structure of a device for information processing according to an embodiment of the present disclosure.

### DETAILED DESCRIPTION

Exemplary embodiments, characteristics, and aspects herein are elaborated below with reference to the drawings. Same reference signs in the drawings may represent elements with the same or similar functions. Although various aspects of the embodiments are illustrated in the drawings, the drawings are not necessarily to scale unless specified otherwise.

The dedicated word “exemplary” may refer to “as an example or an embodiment, or for descriptive purpose”. Any embodiment illustrated herein as being “exemplary” should not be construed as being preferred to or better than another embodiment.

A term “and/or” herein merely describes an association between associated objects, indicating three possible relationships. For example, by A and/or B, it may mean that there may be three cases, namely, existence of but A, existence of both A and B, or existence of but B. In addition, a term “at least one” herein means any one of multiple, or any combination of at least two of the multiple. For example, including at least one of A, B, and C may mean including any one or more elements selected from a set composed of A, B, and C.

Moreover, a great number of details are provided in embodiments below for a better understanding of the present disclosure. A person having ordinary skill in the art may understand that the present disclosure may be implemented without some details. In some embodiments, a method, means, an element, a circuit, etc., that is well-known to a person having ordinary skill in the art may not be elaborated in order to highlight the main point of the present disclosure.

It may be understood that the various method embodiments mentioned in the present disclosure may be combined with each other without departing from the principle and logic, to form a combined embodiment, which will not be repeated in embodiments of the present disclosure due to the space limitation.

The technical solution of the present disclosure will be further elaborated below with reference to the drawings and specific embodiments.

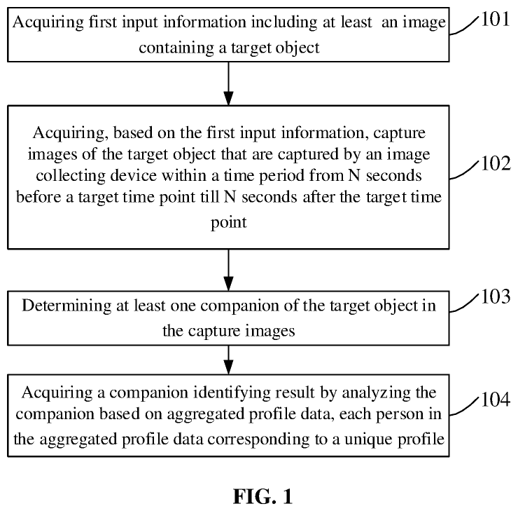

Embodiments of the present disclosure provide a method for information processing. As shown in FIG. 1, the method mainly includes steps as follows.

In S101, first input information is acquired. The first input information at least includes an image containing a target object.

In a possible implementation, the first input information may further include at least one of the following information:

time information, space information, or identification information of image collecting devices.

It should be noted that each image collecting device has an identification that uniquely represents the image collecting device.

In some examples, the space information includes at least geographic location information.

In some examples, the image collecting device has an image collecting function. For example, the image collecting device may be a camera or a snapshot machine.

Exemplarily, the first input information may be input by a public official such as a policeman at a terminal side. The terminal may be connected to a system database that stores aggregated profile data established based on cluster analysis.

In some examples, the image of the target object may be collected by an image collector such as a video camera or a camera, etc., or may also be acquired through scanning by a scanner, or may be received by a communicator. Acquisition of the image of the target object is not limited in embodiments of the present disclosure.

In S102, capture images of the target object that are captured by an image collecting device within a period from N seconds before a target time point till N seconds after the target time point is acquired based on the first input information. The target time point is a time point when the image collecting device captures the target object.

The N is a positive number.

In an optional implementation, the capture images of the target object that are captured by the image collecting device within the period from N seconds before the target time point till N seconds after the target time point is acquired based on the first input information by:

determining one or more image collecting devices based on the first input information;

acquiring images or videos collected by the one or more image collection devices;

determining a target image containing the target object from the images or videos;

finding, using the target image as a reference, from the images or videos the capture images that are captured by the same image collecting device within the period from N seconds before the target time point till N seconds after the target time point.

Specifically, one or more image collecting devices are determined according to the space information.

For example, when the space information represents a residential quarter B in a city A, all cameras in the residential quarter B are determined as image collecting devices to be checked.

For example, there are 10 cameras in the residential quarter B, where cameras 1, 3, and 9 have captured the target object X. The camera 1 has captured image 1 containing the target object X. By using the image 1 as a reference, any image collected by the camera 1 within the period from N seconds before a time point at which the image 1 is captured till N seconds after the time point at which the image 1 is captured may be regarded as a capture image that may contain a companion of the target object X, and may be referred to as a capture database 1. In the same way, the camera 3 has captured image 3 of the target object X. By using the image 3 as a reference, any image collected by the camera 3 within the period from N seconds before a time point at which the image 3 is captured till N seconds after such time point of the image 3 may be regarded as a capture image that may contain a companion of the target object X, and may be referred to as a capture database 3. In the same way, the camera 9 has captured image 9 of the target object X. By using the image 9 as a reference, any image collected by the camera 9 within the period from N seconds before a time point at which the image 9 is captured till N seconds after such time point of the image 9 may be regarded as a capture image that may contain the companions of the target object X, and may be referred to as a capture image database 9. Then, capture images that may contain a companion of the target object X are composed of the capture database 1, the capture database 3, and the capture database 9. In S103, the images in the three capture databases are to be analyzed.

In S103, at least one companion of the target object is determined from the capture images.

In an optional implementation, the companion of the target object is determined from the capture images by:

determining any person other than the target object appearing in the capture images;

determining the any person other than the target object as the companion of the target object.

That is to say, M capture images of the target object that are captured by the image collecting device in the period from N seconds before the target time point till N seconds after the target time point may be found, and any person other than the target object appearing in the M images is defined as companion of the target object.

In S104, a companion identifying result is acquired by analyzing the at least one companion based on aggregated profile data. Each person in the aggregated profile data corresponds to a unique profile.

In embodiments of the present disclosure, the aggregated profile data are system profile data established based on cluster analysis. The aggregated profile data are stored in a system database, and the system database is at least divided into a first database and a second database. The first database is formed based on portrait images captured by the image collecting device. The second database is formed based on real-name image information.

To facilitate understanding, the first database may be referred to as a capture portrait database, which is formed based on the portrait images captured by the image collecting device. The second database may be referred to as a static portrait database, which is formed based on demographic information of citizens who have been authenticated by real names, such as identity numbers.

In some optional implementations, acquiring the companion identifying result by analyzing the companion based on the aggregated profile data includes:

determining companion relevant information of all companions based on the aggregated profile data.

The companion includes an unreal-named companion or a real-named companion, where relevant information of the unreal-named companion includes: capture images of the unreal-named companion in a first database in a system; and relevant information of the real-named companion includes: image information and text information of the real-named companion in a second database in the system.

Therefore, statistical analysis of the capture images is performed based on the aggregated profile data, so as to quickly acquire the relevant information of the companions of the target object, which may help find the suspect's associates and establish a real-name social relation network, thereby greatly facilitating the investigation work.

In a specific example, the terminal side acquires input information. The input information includes a suspect Q, a time period (accurate to seconds), camera identification, and t seconds before and after a time point. Based on the input information, the terminal side finds all capture images that may contain the suspect Q's companion, and aggregates the capture images based on the system database connected to the terminal, and capture images belonging to the same profile are aggregated together. When receiving an output instruction, the terminal outputs the companion relevant information of all companions of suspect Q, where the companion relevant information is specifically divided for real-named and unnamed companions. Specifically, for real-named companion, the companion relevant information includes: images in the database and text information such as ID number, name, address, nationality, etc. For unnamed companion, the companion relevant information includes a capture thumbnail. Herein, the capture thumbnail is with respect to a capture image and is a part of the capture image.

In some optional implementations, acquiring the companion identifying result by analyzing the at least one companion based on the aggregated profile data further includes:

determining the number of companion times for each of the companions and the target object; and

acquiring a companion sequence by sorting the companions based on the number of companion times.

Still considering the above specific example, when receiving an output instruction on the number of companion times, the terminal outputs the number of companion times of all companions of the suspects Q, in a descending or ascending order of the number of companion times.

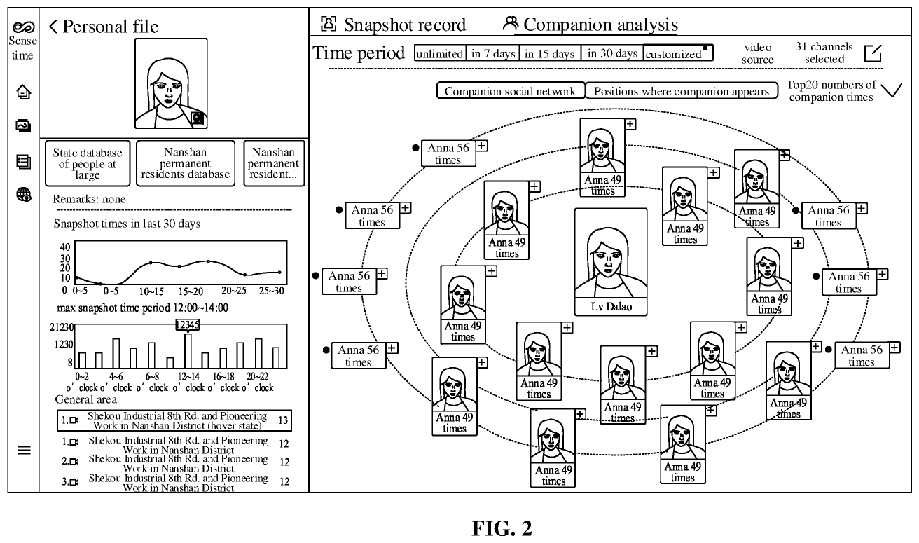

FIG. 2 is a schematic diagram of a query result of companion times according to an embodiment of the disclosure. As shown in FIG. 2, in the query result interface, displayed to the left are the avatar of a companion, the graph of the number of capture times related to the companion in the past 30 days, histogram of the most capture time periods, and the locations of the camera having captured the companion. Displayed to the right side is the number of companion times for the companion in different areas. In this way, information such as the number of companion times is displayed very clearly, which may help find the suspect's associates and establish a companion social network, thereby greatly facilitating the investigation work.

It should be noted that it is understandable that the displayed content and layout information in the interface may be set or adjusted according to a user requirement or a design requirement.

In some optional implementations, acquiring the companion identifying result by analyzing the at least one companion based on the aggregated profile data further includes:

determining a first companion in the companion sequence; and

determining all companion records for the target object and the first companion.

The companion record may include at least: identification information of the image collecting device, capture time, and capture images of the target object and the first companion.

In some examples, the first companion may be any one of all companions.

In this way, after the number of companion times is obtained, a detailed companion record of the target object and a single companion may be queried.

In a specific example, upon determining the number of companion times and companion relevant information for all companions of a suspect Q, the terminal side receives input information including a companion G (the companion G is one of all companions of the suspect Q). The terminal searches for all the records of the suspect Q and the companion G. When receiving an output instruction, the terminal outputs the relevant information that each time Q accompanies G, including a capture thumbnail and a large capture of Q and G, the capture time, and the camera information, and displays the result according to the capture time in a sequential order or a reverse order. Herein, the capture thumbnail is with respect to a capture image and is a part of the capture image. The large capture image is with respect to the capture thumbnail and is the entire capture image.

That is to say, the terminal supports querying data by the following manner: profile ID of target object+profile ID of one companion+time range+camera ID, sorted page by page and listed.

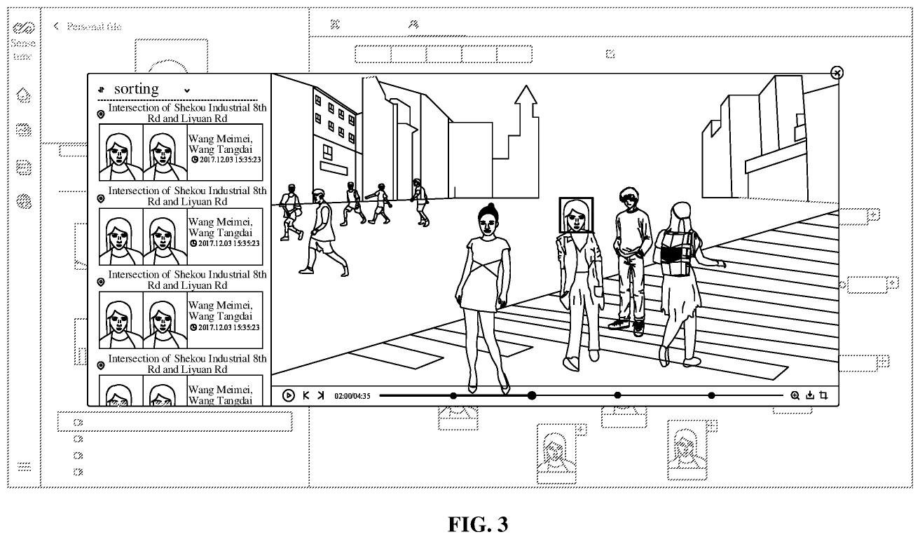

FIG. 3 is a diagram of a query result of a companion record for a target object and a companion according to an embodiment of the disclosure. As shown in FIG. 3, on the basis of the schematic result of FIG. 2, the left side shows the capture images of the target object and the companion, the area of the camera that has captured the target object and the companion, and camera information. The video that the target object accompanies the companion is shown on the right side. In this way, the companion record information for a single companion is displayed very clearly, which may help find the suspect's companions, and establish a companion social network, thereby greatly facilitating the investigation.

It should be noted that it is understandable that the displayed content and layout information in the interface may be set or adjusted according to a user requirement or a design requirement.

In some optional implementations, acquiring the companion identifying result by analyzing the at least one companion based on the aggregated profile data further includes:

determining K companions based on the companion sequence, the K being a positive integer; and

determining all companion records for the target object and each of the K companions.

The companion record may include at least: identification information of the image collecting device, capture time, and capture images of the target object and each of the K companions.

Herein, the K companions may be understood as the top K companions in the companion sequence.

In this way, after the number of companion times are acquired, the companion records for the K companions may be counted.

In some optional implementations, acquiring the companion identifying result by analyzing the at least one companion based on the aggregated profile data further includes:

counting the number of capture times of the K companions by each image collecting device based on all companion records of the target object and the K companions.

In this way, after the companion records are acquired, the number of capture times of the K companions may be counted.

In a specific example, when determining the number of companion times and companion related information for all companions of the suspect Q, the terminal side receives input information, the input information including TOP K, i.e., the top K companions with the most companion times (K may be unlimited). The terminal counts the number of capture times that the suspect Q's TOP K companions are captured by each camera. When receiving an output instruction, the terminal outputs the number of capture times that the suspect Q's companions are captured by each camera.

That is to say, the terminal supports the flowing query manner: profile IDs of multiple companion+time range+multiple camera IDs, to count the number of capture times for the cameras.

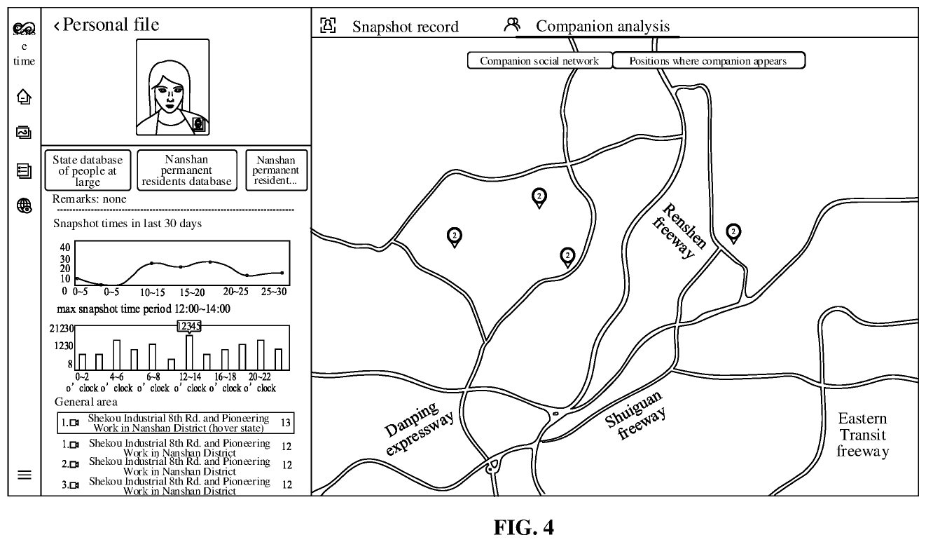

FIG. 4 is a schematic diagram of a query result of positions where a companion appears according to an embodiment of the disclosure. As shown in FIG. 4, on the basis of the schematic diagram of the query result in FIG. 2, displayed to the left are the avatar of a companion, the graph of the number of capture times related to the companion in the past 30 days, histogram of the most captured time periods, and areas including cameras having captured the companion. Displayed to the right side is the number of capture times for each camera marked on the map. In this way, the number of capture times for the companion by each camera is displayed very clearly, which may help find the suspect's accomplices and determine a search network, thereby greatly facilitating the investigation work.

It should be noted that it is understandable that the displayed content and layout information in the interface may be set or adjusted according to a user requirement or a design requirement.

In some optional implementations, acquiring the companion identifying result by analyzing the at least one companion based on the aggregated profile data further includes:

acquiring a designated video stream collected by a designated image collecting device; and

searching in all companion records for a companion record of the target object and each of the K companions under the designated video stream.

In this way, it is possible to filter out the companion records of TOP K companions that appear in a designated video source.

In a specific example, when determining the number of companion times and companion related information for all companions of the suspect Q, the terminal side receives input information, the input information including TOP K companions, i.e., the top K companions with the most companion times (K may be unlimited) and a video source. The terminal counts the positions where the suspect Q's TOP K companions appear under the designated video source. When receiving the output instruction, the terminal outputs the relevant information of the suspect Q and a TOP K companion pairwise appearing in the designated video source, where the relevant information includes a capture thumbnail and a large capture image of Q and the companion, the capture time, and the camera information, and displays the result according to the capture time in a sequential order or a reverse order.

That is to say, the terminal supports querying data by the following manner: profile ID of a target object+profile IDs of multiple companions+time range+multiple camera IDs, sorted page by page and listed.

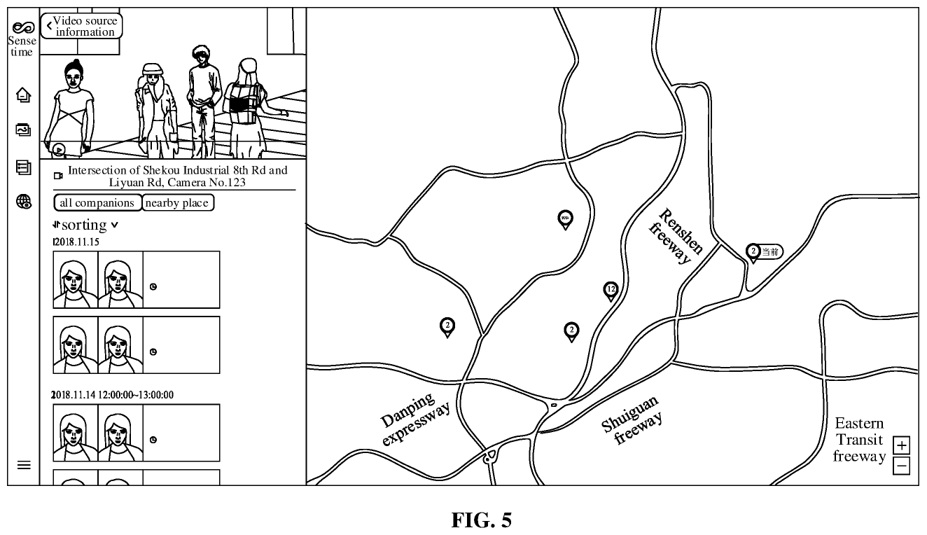

FIG. 5 is a schematic diagram of analysis result of a single video source according to an embodiment of the disclosure. As shown in FIG. 5, based on the schematic diagram of the result of FIG. 2, a designated video source, camera information corresponding to the designated video source, avatars of the target object and the companions, and companion time are displayed to the left. Locations of the cameras corresponding to the designated video source marked on the map are displayed to the right. In this way, companion analysis is performed on a single designated video source, which may help find the suspect's accomplices and determine a search network, thereby greatly facilitating the investigation work.

It should be noted that it is understandable that the displayed content and layout information in the interface may be set or adjusted according to a user requirement or a design requirement.

With the technical solution provided by embodiments of the present disclosure, a companion of a target object can be identified quickly by determining the companion via a capture image. By performing aggregation analysis on the companion based on the aggregated profile data in the system, the relevant information of the companion can be quickly determined, which helps improve accuracy in companion identification.

The technical solution described in the present disclosure may be applied to the field such as smart video analysis, security monitoring, etc. For example, it may be applied to investigate cases such as burglary, anti-terrorism monitoring, medical disturbances, drug-related crackdowns, critical national security, community management and control, etc. For example, once a crime has committed, the police have a portrait photo of a suspect F. The photo of the suspect is uploaded in use of the companion analysis tactics, and the time period the crime was committed is set. Then, the profile of a person who has accompanied the suspect F for Y times or more may be found around the scene d of the crime, so as to find action track of the companion, thereby confirming the location of the companion. After finding the photo of the companion, the above steps are repeated to find more photos of more possible companions. In this way, it is convenient for the police to establish ties among clues to improve the efficiency of cracking case.

In the above solution, before the step 101, optionally, the method further includes a step as follows. Aggregated profile data are established based on cluster analysis.

In some optional implementations, aggregated profile data are established based on cluster analysis by:

acquiring a clustering processing result by performing clustering processing on image data in a first database, the first database being formed based on portrait images captured by the image collecting device;

acquiring an aggregation processing result by performing aggregation processing on image data in a second database, the second database being formed based on real-name image information; and

acquiring the aggregated profile data by associating the clustering processing result with the aggregation processing result.

In this way, all profile information of a person in the system may be acquired.

In some optional implementations, performing clustering processing on the image data in the first database includes:

extracting face image data from the image data in the first database; and

dividing the face image data into multiple classes. Each of the multiple classes may have a class center. The class center may include a class center feature value.

In this way, it is proposed a method for clustering faces in numerous capture images of portrait. That is, the collection of faces is divided into multiple classes composed of similar faces. A class generated by clustering is a collection of a set of data objects. The objects are similar to objects in the same class, but different from objects in other classes.

Specifically, the face image data may be divided into several classes by using an existing clustering algorithm.

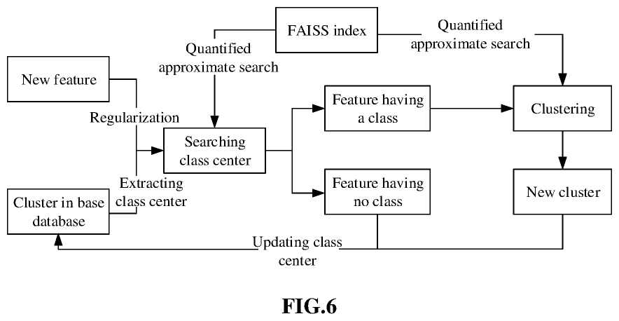

FIG. 6 is a schematic diagram of a principle of a face clustering algorithm according to an embodiment of the present disclosure. As shown in FIG. 6, the principle of a face clustering algorithm mainly includes the following three steps.

In the first step, nearest-neighbor search is performed on a new input feature and a class center of a base database. It is determined, via a FAISS index, whether the new input feature belongs to the existing base database, that is, whether it has a class.

Herein, FAISS is the abbreviation of Facebook AI Similarity Search, with the Chinese name of open source similarity search database.

In the second step, a feature having a class is processed by being clustered into the existing class. The class center in the base database is then updated.

In the third step, a feature having no class is processed by being clustered to determine a class, and adding a new cluster center to class centers of the base database.

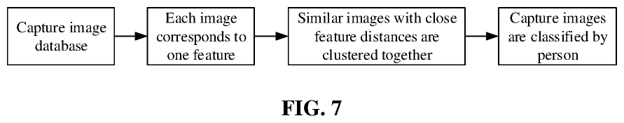

FIG. 7 is a flowchart of face clustering according to an embodiment of the present disclosure. As shown in FIG. 7, a capture image database is determined first. Then a feature is determined for each image in the capture image database. Similar images with close feature distances are clustered together. Images in the capture image database are classified based on the aggregation result.

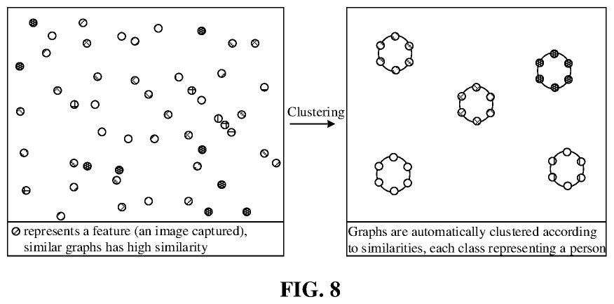

FIG. 8 is a diagram of a face clustering result according to an embodiment of the present disclosure. As shown in FIG. 8, each graph on the left diagram represents a feature or a photo captured, where similar shapes indicate high similarity. The right diagram shows graphs after cluster processing, which are automatically clustered according to similarities, one class representing one person.

In some optional implementations, acquiring the aggregation processing result by performing aggregation processing on the image data in the second database includes:

aggregating image data with the same identity number into an image database; and

acquiring an aggregation processing result by establishing an association between the image database and text information corresponding to the identity number. Each identity number in the aggregation processing result may correspond to unique profile data.

In other words, in the second database, image data having the same identity number are clustered into one profile.

In some optional implementations, associating the clustering processing result with the aggregation processing result includes:

acquiring a total comparison result by performing total comparison on each class center feature value in the first database with each reference class center feature value in the second database;

determining a target reference class center feature value with a highest similarity greater than a preset threshold based on the total comparison result;

searching in the second database for a target portrait corresponding to the target reference class center feature value and identity information corresponding to the target portrait; and

establishing an association between the identity information corresponding to the target portrait and an image corresponding to the class center feature value in the first database.

In this way, identity information corresponding to an image with the highest similarity is assigned to a class of the capture image database, so that the class of capture portraits is in real-name.

In the above solution, optionally, the method further includes:

in a case of adding new image data to the first database, dividing face image data in the new image data into multiple classes by performing clustering processing on the new image data, and querying whether there is a class in the first database same as one of the multiple classes; if there is a class same as a first class in the multiple classes, merging image data of the first class into an existing profile of the first class; if there is no class same as a second class in the multiple classes, establishing a new profile based on the second class and adding the new profile to the first database.

Herein, the existing profile of the first class is a profile of the first class that has been in the first database, and each class corresponds to a unique profile in the first database.

In this way, when there is a new increase in the database, the profile data in the system can be updated or supplemented in time.

In the above solution, optionally, the method further includes:

in a case of adding new image data to the second database, querying whether there is an identity number in the second database same as the new image data; if there is a first identity number same as first image data in the new image data, merging the first image data into an existing profile corresponding to the first identity number; if there is not a second identity number same as second image data in the new image data, establishing a new profile based on the second identity number in the second image data, and adding the new profile to the second database.

Herein, the existing profile corresponding to the first identity number is a profile of the first identity number that has been in the second database. In the second database, each identity number corresponds to a unique profile.

In this way, when there is a new increase in the database, the system profile data may be updated or supplemented in time.

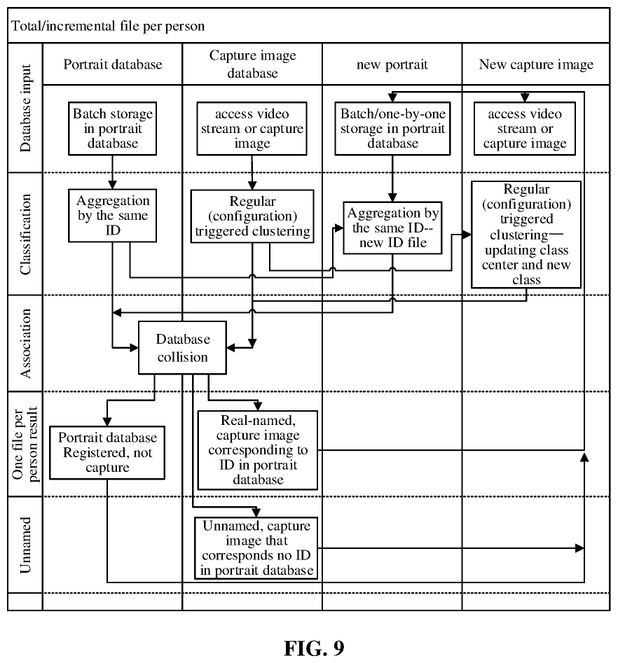

FIG. 9 is a flowchart of establishing a profile according to an embodiment of the present disclosure. As shown in FIG. 9, the flow mainly includes five parts of: database input, classification, association, one profile per person, and unnamed profiles. For a portrait database, a batch of portraits is stored in the database, and portraits with the same identity number are aggregated into one profile. For the capture image database, a batch of capture images is stored in the database, or a video stream is accessed, and clustering is triggered at regular intervals, such as once an hour or once a day, which is configurable. It is total clustering at first, and then incremental clustering for aggregation into an existing class, or automatically aggregated into a new class when there is no similar class. New portraits may be stored in the database in batch or one by one. It is queried whether there is an identity number in existing profiles in the portrait database that is the same as a new portrait. If so, the new portrait is aggregated into the profile corresponding to the same identity number; or if there is no identity number same as the new portrait, a new profile is established for the new portrait. New capture images may be stored in the database in batch or one by one, or a video stream is accessed. Clustering is triggered at regular intervals. It is queried whether there is a class the same as the new capture images in existing profiles of the capture image database. If so, the new capture images are aggregated into a profile of the same class; if there is no class same as the new capture images, a new profile is established for the new capture images. Database collision operation is performed on the portrait database with the class center of the new class. Specifically, for collision between capture image database and portrait database, the capture image database is divided into multiple classes (of people) after clustering. Each class has a class center, which corresponds to a class center feature value. Total comparison in a ratio of 1:n is then performed on each class center feature value and the portrait database. A portrait with the highest similarity TOP1 greater than a preset threshold is selected. The identity information corresponding to the portrait with TOP1 is assigned to the class of the capture image database, so that the class of capture portraits is associated with a real name.

It may be seen that the portrait database (static database) with citizen IDs is used as a reference database. Face capture images with time and space information captured by a snapshot machine are clustered. Pairwise similarity is used as the criterion to associate information in the face recognition system seemingly of one person, so that one person has a unique comprehensive profile. An attribute feature, a behavioral feature, etc., of a suspect may be acquired from the profiles.

In this way, conditional filtering is performed on all clustered profiles (including real-named and unnamed profiles), to find out the profile information of a person the number of capture images of whom in the specified video source within the specified time range exceeds a certain threshold. After acquiring the profile information, the user may quickly find the companion accompanying the suspect in an area within a time period from t seconds before a target time point till t seconds after the target time point according to portrait information of the suspect, and companion capture images which meets the above conditions are aggregated; Or, the detailed companion record of the suspect Q accompanied by a single companion G may be inquired based on the number of companion times, to determine the companion records and companion social networks of some suspects.

Compared with the existing problem that it is difficult to achieve efficient automatic classification under a massive data scenario, the present disclosure may automatically classify massive capture images, and may also automatically associate massive capture images of suspect in video surveillance with information in existing public security personnel database efficiently. With the technical solution described in the present disclosure, capture images of all companions of the target object are found according to a specified condition input, and the capture images of the companions are further aggregated (aggregating capture images belonging to the same profile). Therefore, companion analysis can be carried out based on the target object's profile, and the companion social network is further clarified, so that capture information of all companions is utilized efficiently.

With the technical solution provided by embodiments of the present disclosure, first input information is acquired, where the first input information includes at least an image containing a target object. Capture images of the target object that are captured by an image collecting device within a period from N seconds before a target time point till N seconds after the target time point is acquired based on the first input information, where the target time point is a time point when the image collecting device captures the target object. At least one companion of the target object is determined in the capture images. A companion identifying result is acquired by analyzing the at least one companion based on aggregated profile data, where each person in the aggregated profile data corresponds to a unique profile. In this way, multiple capture images are captured automatically such that companions of a target can be identified quickly, and since the aggregated profile data are established one profile per person, which helps quickly determine companion relevant information of the companions.

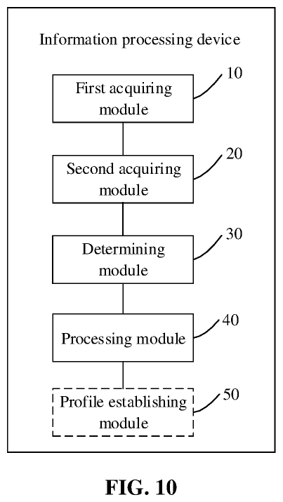

Embodiments of the present disclosure further provide a device for information processing. As shown in FIG. 10, the device includes:

a first acquiring module 10, configured for acquiring first input information, the first input information including at least an image containing a target object;

a second acquiring module 20, configured for acquiring, based on the first input information, capture images of the target object that are captured by an image collecting device within a time period from N seconds before a target time point till N seconds after the target time point, the target time point being a time point when the image collecting device captures the target object;

a determining module 30, configured for determining at least one companion of the target object in the capture images; and

a processing module 40 configured for acquiring a companion identifying result by analyzing the at least one companion based on aggregated profile data, each person in the aggregated profile data corresponding to a unique profile.

As an implementation, the processing module 40 is further configured for:

determining relevant information of all companions based on the aggregated profile data.

Each companion includes an unreal-named companion or a real-named companion, where relevant information of the unreal-named companion includes: each capture image of the unreal-named companion in a first database in a system; and relevant information of the real-named companion includes: image information and text information of the real-named companion in a second database in the system.

As an implementation, the processing module 40 is further configured for:

determining the number of companion times for each of the companions and the target object; and

acquiring a companion sequence by sorting the companions based on the number of companion times.

As an implementation, the processing module 40 is further configured for:

determining a first companion in the companion sequence; and

determining all companion records for the target object and the first companion.

The companion record may include at least: identification information of the image collecting device, capture time, and capture images of the target object and the first companion.

As an implementation, the processing module 40 is further configured for:

determining K companions based on the companion sequence, the K being a positive integer; and

determining each of all companion records for the target object and each of the K companions.

The companion record may include at least: identification information of the image collecting device, capture time, and capture images of the target object and the K companions.

As an implementation, the processing module 40 is further configured for:

acquiring a designated video stream collected by a designated image collecting device; and

searching in all companion records for a companion record of the target object and each of the K companions in the designated video stream.

As an implementation, the processing module 40 is further configured for:

counting the number of capture times that the K companions are captured by each image collecting device based on the companion records of the target object and each of the K companions.

In the above solution, optionally, the device further includes a profile establishing module 50 configured for:

acquiring a clustering processing result by performing clustering processing on image data in a first database, the first database being formed based on portrait images captured by the image collecting device;

acquiring an aggregation processing result by performing aggregation processing on image data in a second database, the second database being formed based on real-name image information; and

acquiring the aggregated profile data by associating the clustering processing result with the aggregation processing result.

As an implementation, the profile establishing module 50 is further configured for:

extracting face image data from the image data in the first database; and

dividing the face image data into multiple classes. Each of the multiple classes may have a class center. The class center may include a class center feature value.

As an implementation, the profile establishing module 50 is further configured for:

aggregating image data with the same identity number into an image database; and

acquiring an aggregation processing result by establishing an association between the image database and text information corresponding to the same identity number. Each identity number in the aggregation processing result may correspond to unique profile data.

As an implementation, the profile establishing module 50 is further configured for:

acquiring a total comparison result by performing total comparison on each class center feature value in the first database and each reference class center feature value in the second database;

determining a target reference class center feature value with the highest similarity greater than a preset threshold based on the total comparison result;

searching in the second database for a target portrait corresponding to the target reference class center feature value and identity information corresponding to the target portrait; and establishing an association between the identity information corresponding to the target portrait and an image corresponding to the each class center feature value in the first database.

As an implementation, the profile establishing module 50 is further configured for:

in a case of adding new image data to the first database, dividing face image data in the new image data into multiple classes by performing clustering processing on the new image data, and querying whether there is a class in the first database same as one of the multiple classes; if there is a class same as a first class in the multiple classes, merging image data of the first class into an existing profile of the first class; if there is no class same as a second class in the multiple classes, establishing a new profile based on the second class and adding the new profile to the first database.

As an implementation, the profile establishing module 50 is further configured for:

in a case of adding new image data to the second database, querying whether there is an identity number in the second database same as the new image data; if there is a first identity number same as first image data in the new image data, merging the first image data into an existing profile corresponding to the first identity number; if there is not a second identity number same as second image data in the new image data, establishing a new profile based on the second identity number in the second image data and adding the new profile to the second database.

A skilled person in the art should understand that, in some optional embodiments, the function of processing modules in the device for information processing shown in FIG. 10 may be understood with reference to the relevant description of the foregoing method for information processing.

A skilled person in the art should understand that in some optional embodiments, the function of each processing unit in the device for information processing shown in FIG. 10 may be implemented by a program running on a processor, or may be implemented by a specific logic circuit.

In a practical application, the specific structures of the first acquiring module 10, the second acquiring module 20, the determining module 30, the processing module 40, and the profile establishing module 50 described above may all correspond to a processor. The specific structure of the processor may be an electronic component or a collection of electronic components with a processing function, such as a Central Processing Unit (CPU), a Micro Controller Unit (MCU), a Digital Signal Processing (DSP), or a Programmable Logic Controller (PLC). The processor includes an executable code. The executable code is stored in a storage medium. The processor may be connected to the storage medium through a communication interface such as a bus. When performing a function corresponding to a specific unit, the executable code in the storage medium is read and run. The part of the storage medium for storing the executable code is preferably a non-transitory storage medium.

The first acquiring module 10, the second acquiring module 20, the determining module 30, the processing module 40, and the profile establishing module 50 may be integrated in and correspond to the same processor, or correspond respectively to different processors; when integrated in and correspond to the same processor, the processor processes the functions corresponding to the first acquiring module 10, the second acquiring module 20, the determining module 30, the processing module 40, and the profile establishing module 50 by time division.

The device for information processing provided by embodiments of the present disclosure determines a companion and companion related information by performing aggregation analysis on capture images based on aggregated profile data, which helps improve accuracy in companion identification.

Embodiments of the present disclosure also provide a device for information processing. The device includes memory, a processor, and a computer program stored in the memory and executable by the processor. The processor is configured to execute the computer program to implement the method according to any of the aforementioned technical solutions.

In embodiments of the disclosure, the processor executes the program to implement:

acquiring first input information, the first input information including at least an image containing a target object;

acquiring, based on the first input information, capture images of the target object that are captured by an image collecting device within a period from N seconds before a target time point till N seconds after the target time point, the target time point being a time point when the image collecting device captures the target object;

determining a companion of the target object in the capture images; and

acquiring a companion identifying result by analyzing the companion based on aggregated profile data. Each person in the aggregated profile data corresponds to a unique profile.

As an implementation, the processor executes the program to implement:

determining relevant information of each of all companions based on the aggregated profile data.

Each companion includes an unreal-named companion or a real-named companion, where relevant information of the unreal-named companion includes: each capture image of the unreal-named companion in a first database in a system; and relevant information of the real-named companion includes: image information and text information of the real-named companion in a second database in the system.

As an implementation, the processor executes the program to implement:

determining the number of companion times for each of the companions and the target object; and

acquiring a companion sequence by sorting the companions based on the number of companion times.

As an implementation, the processor executes the program to implement:

determining a first companion in the companion sequence; and

determining all companion records for the target object and the first companion.

The companion record may include at least: identification information of the image collecting device, capture time, and capture images of the target object and the first companion.

As an implementation, the processor executes the program to implement:

determining K companions based on the companion sequence, the K being a positive integer; and

determining each of all companion records for the target object and each of the K companions.

The companion record may include at least: identification information of the image collecting device, capture time, and capture images of the target object and the K companions.

As an implementation, the processor executes the program to implement:

acquiring a designated video stream collected by a designated image collecting device; and

searching in the companion records for a companion record of the target object and the K companions in the designated video stream.

As an implementation, the processor executes the program to implement:

counting the number of capture times that each image collecting device captures the K companions based on the all companion records of the target object and the K companions.

As an implementation, the processor executes the program to implement:

acquiring a clustering processing result by performing clustering processing on image data in a first database, the first database being formed based on portrait images captured by the image collecting device;

acquiring an aggregation processing result by performing aggregation processing on image data in a second database, the second database being formed based on real-name image information; and

acquiring the aggregated profile data by associating the clustering processing result with the aggregation processing result.

As an implementation, the processor executes the program to implement:

extracting face image data from the image data in the first database; and

dividing the face image data into multiple classes. Each of the multiple classes may have a class center. The class center may include a class center feature value.

As an implementation, the processor executes the program to implement:

aggregating image data with the same identity number into an image database; and

acquiring an aggregation processing result by establishing an association between the image database and text information corresponding to the identity number. Each identity number in the aggregation processing result may correspond to unique profile data.

As an implementation, the processor executes the program to implement:

acquiring a total comparison result by performing total comparison on each class center feature value in the first database with each reference class center feature value in the second database;

determining a target reference class center feature value with the highest similarity greater than a preset threshold based on the total comparison result;

searching the second database for a target portrait corresponding to the target reference class center feature value and identity information corresponding to the target portrait; and

establishing an association between the identity information corresponding to the target portrait and an image corresponding to the each class center feature value in the first database.

As an implementation, the processor executes the program to implement:

in a case of adding new image data to the first database, dividing face image data in the new image data into multiple classes by performing clustering processing on the new image data, and querying whether there is a class in the first database same as one of the multiple classes; if there is a class same as a first class in the multiple classes, merging image data of the first class into an existing profile of the first class; if there is no class same as a second class in the multiple classes, establishing a new profile based on the second class and adding the new profile to the first database.

As an implementation, the processor executes the program to implement:

in a case of adding new image data to the second database, querying whether there is an identity number in the second database same as the new image data; if there is a first identity number same as first image data in the new image data, merging the first image data into an existing profile corresponding to the first identity number; if there is not a second identity number same as second image data in the new image data, establishing a new profile based on the second identity number in the second image data and adding the new profile to the second database.

The device for information processing provided by embodiments of the present disclosure determines a companion and related information to the companion by performing aggregation analysis on a capture image based on aggregated profile data, which helps improve accuracy in companion identification.

Embodiments of the present disclosure also provide a computer storage medium, having stored thereon computer-executable instructions for implementing the method for information processing according to any of the foregoing embodiments. In other words, the computer-executable instructions, when executed by a processor, may implement the method for information processing according to any of the aforementioned technical solutions.

A skilled person in the art should understand that the function of each program in the computer storage medium of the embodiment may be understood with reference to relevant description of the method for information processing according to various foregoing embodiments. The computer storage medium may be a volatile computer-readable storage medium or a non-volatile computer-readable storage medium.

Embodiments of the present disclosure also provide a computer program product including a computer-readable code which, when run on equipment, allows a processor of the equipment to implement the method according to any of the aforementioned embodiments.

The computer program product may be specifically implemented by hardware, software or a combination thereof. In an optional embodiment, the computer program product is specifically embodied as a computer storage medium. In another optional embodiment, the computer program product is specifically embodied as a software product, such as a Software Development Kit (SDK), etc.

A skilled person in the art should understand that the function of each program in the computer storage medium of the embodiment may be understood with reference to relevant description of the method for information processing according to various foregoing embodiments.

According to the technical solution described in the present disclosure, the capture images of the same person in the video surveillance are combined with the existing static personnel database, which allows the police to connect clues, thereby improving the case solving efficiency. For example, when investigating a gang crime, other criminal suspects are found based on the companions; the suspect's social relations is learnt by analyzing the suspect's companions, thereby investigating the suspect's identity and whereabouts.

It should also be understood that various interfaces listed herein are merely exemplary to help a person having ordinary skill in the art better understand a technical solution described in the present disclosure, and should not be construed as limiting embodiments herein. A person of ordinary skill may make various changes and substitutions to an interface herein. They should also be construed as part of embodiments herein.

In addition, a technical solution is described herein focusing on differences among embodiments. Refer to one another for identical or similar parts among embodiments, which are not repeated for conciseness.

IT should be understood that in embodiments provided herein, the disclosed equipment and method may be implemented in other ways. The described equipment embodiments are merely exemplary. For example, the unit division is merely logical function division and may be other division in actual implementation. For example, multiple units or components may be combined, or integrated into another system, or some features/characteristics may be omitted or skipped. Furthermore, the coupling, or direct coupling or communicational connection among the components illustrated or discussed herein may be implemented through indirect coupling or communicational connection among some interfaces, equipment, or units, and may be electrical, mechanical, or in other forms.

The units described as separate components may or may not be physically separated. Components shown as units may be or may not be physical units. They may be located in one place, or distributed on multiple network units. Some or all of the units may be selected to achieve the purpose of a solution of the present embodiments as needed.

In addition, various functional units in each embodiment of the present disclosure may be integrated in one processing unit, or exist as separate units respectively; or two or more such units may be integrated in one unit. The integrated unit may be implemented in form of hardware, or hardware plus software functional unit(s).

A skilled person in the art may understand that all or part of the steps of embodiments may be implemented by instructing a related hardware through a program, which program may be stored in a (non-transitory) computer-readable storage medium and when executed, execute steps including those of embodiments. The computer-readable storage medium may be various media that may store program codes, such as mobile storage equipment, Read Only Memory (ROM), a magnetic disk, a CD, and/or the like.

Or, when implemented in form of a software functional module and sold or used as an independent product, an integrated module herein may also be stored in a computer-readable storage medium. Based on such an understanding, the essential part or a part contributing to prior art of the technical solution of an embodiment of the present disclosure may appear in form of a software product, which software product is stored in storage media, and includes a number of instructions for allowing computer equipment (such as a personal computer, a server, network equipment, and/or the like) to execute all or part of the methods in various embodiments herein. The storage media include various media that may store program codes, such as mobile storage equipment, ROM, RAM, a magnetic disk, a CD, and/or the like.

What described are but embodiments herein and are not intended to limit the scope of the present disclosure. Any modification, equivalent replacement, and/or the like made within the technical scope of the present disclosure, as may occur to a person having ordinary skill in the art, shall be included in the scope of the present disclosure. The scope of the present disclosure thus should be determined by the claims.

### INDUSTRIAL APPLICABILITY

With the technical solution provided by embodiments of the present disclosure, first input information is acquired, where the first input information at least includes an image containing a target object. Capture images of the target object that are captured by an image collecting device within a period from N seconds before a target time point till N seconds after the target time point is acquired based on the first input information. The target time point is a time point when the image collecting device captures the target object. At least one companion of the target object in the capture image is determined. A companion identifying result is acquired by analyzing the at least one companion based on aggregated profile data. Each person in the aggregated profile data corresponds to a unique profile. In this way, by automatically analyzing multiple capture images, a companion of a target can be identified quickly, and aggregated profile data are established one profile per person, which helps quickly determine companion relevant information.

1. A method for information processing, comprising:
acquiring first input information, the first input information at least comprising an image containing a target object;
acquiring, based on the first input information, capture images of the target object that are captured by an image collecting device within a time period from N seconds before a target time point till N seconds after the target time point, the target time point being a time point when the image collecting device captures the target object;
determining one or more companions of the target object in the capture images; and
acquiring a companion identifying result by analyzing the one or more companions based on aggregated profile data, each person in the aggregated profile data corresponding to a unique profile.

2. The method of claim 1, wherein acquiring the companion identifying result by analyzing the one or more companions based on the aggregated profile data comprises:
determining relevant information of all companions based on the aggregated profile data,
wherein each companion comprises an unreal-named companion or a real-named companion, and wherein relevant information of the unreal-named companion comprises: each capture image of the unreal-named companion in a first database in a system; and relevant information of the real-named companion comprises: image information and text information of the real-named companion in a second database in the system.

3. The method of claim 1, wherein acquiring the companion identifying result by analyzing the one or more companions based on the aggregated profile data further comprises:
determining a number of companion times for each companion and the target object; and
acquiring a companion sequence by sorting the companions based on the number of companion times.

4. The method of claim 3, wherein acquiring the companion identifying result by analyzing the one or more companions based on the aggregated profile data further comprises:
determining a first companion in the companion sequence; and
determining all companion records for the target object and the first companion,
each companion record comprising at least: identification information of the image collecting devices, capture time, and capture images of the target object and the first companion.

5. The method of claim 3, wherein acquiring the companion identifying result by analyzing the one or more companions based on the aggregated profile data further comprises:
determining K companions based on the companion sequence, the K being a positive integer; and
determining all companion records for the target object and each of the K companions,
each companion record comprising at least: identification information of the image collecting devices, capture time, and capture images of the target object and the K companions.

6. The method of claim 5, further comprising:
acquiring a designated video stream collected by a designated image collecting device; and
searching in the companion records for a companion record of the target object and each of the K companions in the designated video stream.

7. The method of claim 5, wherein acquiring the companion identifying result by analyzing the one or more companions based on the aggregated profile data further comprises:
counting a number of capture times that the K companions are captured by each image collecting device based on the companion records of the target object and each of the K companions.

8. The method of claim 1, wherein before acquiring the first input information, the method further comprises:
acquiring a clustering processing result by performing clustering processing on image data in a first database, the first database being formed based on portrait images captured by the image collecting device;
acquiring an aggregation processing result by performing aggregation processing on image data in a second database, the second database being formed based on real-name image information; and
acquiring the aggregated profile data by associating the clustering processing result with the aggregation processing result.

9. The method of claim 8, wherein performing clustering processing on the image data in the first database comprises:
extracting face image data from the image data in the first database; and
dividing the face image data into multiple classes, each of the multiple classes having a class center, the class center comprising a class center feature value.

10. The method of claim 8, wherein acquiring the aggregation processing result by performing aggregation processing on the image data in the second database comprises:
aggregating image data with a same identity number into an image database; and
acquiring an aggregation processing result by establishing an association between the image database and text information corresponding to the identity number, each identity number in the aggregation processing result corresponding to unique profile data.

11. The method of claim 8, wherein associating the clustering processing result with the aggregation processing result comprises:
acquiring a total comparison result by performing total comparison on each class center feature value in the first database with each reference class center feature value in the second database;
determining a target reference class center feature value with a highest similarity greater than a preset threshold based on the total comparison result;
searching in the second database for a target portrait corresponding to the target reference class center feature value and identity information corresponding to the target portrait; and
establishing an association between the identity information corresponding to the target portrait and an image corresponding to the class center feature value in the first database.

12. The method of claim 8, further comprising:
in a case of adding new image data to the first database, dividing face image data in the new image data into multiple classes by performing clustering processing on the new image data, and querying whether there is a class in the first database same as one of the multiple classes; and
in response to there being a class same as a first class in the multiple classes, merging image data of the first class into an existing profile of the first class; or in response to there being no class same as a second class in the multiple classes, establishing a new profile based on the second class and adding the new profile to the first database.

13. The method of claim 8, further comprising:
in a case of adding new image data to the second database, querying whether there is an identity number in the second database same as the new image data; in response to there being a first identity number same as first image data in the new image data, merging the first image data into an existing profile corresponding to the first identity number; in response to there being not a second identity number same as second image data in the new image data, establishing a new profile based on the second identity number in the second image data, and adding the new profile to the second database.

14. A device for information processing, comprising: a processor, and a memory for storing instruction executed by the processor, wherein the processor is configured for:
acquiring first input information, the first input information at least comprising an image containing a target object;
acquiring, based on the first input information, capture images of the target object that are captured by an image collecting device within a period from N seconds before a target time point till N seconds after the target time point, the target time point being a time point when the image collecting device captures the target object;
determining one or more companions of the target object in the capture images; and
acquiring a companion identifying result by analyzing the one or more companions based on aggregated profile data, each person in the aggregated profile data corresponding to a unique profile.

15. The device of claim 14, wherein the processor is further configured for:
determining relevant information of all companions based on the aggregated profile data,
wherein each companion comprises an unreal-named companion or a real-named companion, and wherein relevant information of the unreal-named companion comprises: each capture image of the unreal-named companion in a first database in a system; and relevant information of the real-named companion comprises: image information and text information of the real-named companion in a second database in the system.

16. The device of claim 14, wherein the processor is further configured for:
determining a number of companion times for each companion and the target object; and
acquiring a companion sequence by sorting the companions based on the number of companion times.

17. The device of claim 16, wherein the processor is further configured for:
determining a first companion in the companion sequence; and
determining all companion records for the target object and the first companion,
each companion record comprising at least: identification information of the image collecting devices, capture time, and capture images of the target object and the first companion.

18. The device of claim 16, wherein the processor is further configured for:
determining K companions based on the companion sequence, the K being a positive integer; and
determining all companion records for the target object and each of the K companions,
each companion record comprising at least: identification information of the image collecting devices, capture time, and capture images of the target object and the K companions.

19. The device of claim 18, wherein the processor is further configured for:
counting a number of capture times that the K companions are captured by each image collecting device based on the companion records of the target object and each of the K companions.

20. A non-transitory computer storage medium, having stored thereon a computer program which, when executed by a processor, enables the processor to implement the following operations:
acquiring first input information, the first input information at least comprising an image containing a target object;
acquiring, based on the first input information, capture images of the target object that are captured by an image collecting device within a time period from N seconds before a target time point till N seconds after the target time point, the target time point being a time point when the image collecting device captures the target object;
determining one or more companions of the target object in the capture images; and
acquiring a companion identifying result by analyzing the one or more companions based on aggregated profile data, each person in the aggregated profile data corresponding to a unique profile.
